(19) United States
(12) Patent Application Publication
(10) Pub. No.: US 2026/0017058 A1
(43) Pub. Date: Jan. 15, 2026

(54) Systems and Methods to Provide Instructions to Coprocessors

(71) Applicant: TEXAS INSTRUMENTS INCORPORATED, Dallas, TX (US)

(72) Inventors: Venkatesh Natarajan, Bangalore (IN); Alexandar Tessarolo, Lindfield (AU)

(21) Appl. No.: 18/810,333

(22) Filed: Aug. 20, 2024

(30) Foreign Application Priority Data
Jul. 10, 2024 (IN) 202441052912

(51) Int. Cl. G06F 9/38; G06F 9/30

(52) U.S. Cl. CPC G06F 9/3812; G06F 9/30185

(57) ABSTRACT

A method may include a processor core fetching a packet of machine code instructions and then determining whether a first machine code instruction of the packet corresponds to a coprocessor operation. In response to determining that the first machine code instruction corresponds to a coprocessor operation, the processor core may treat the other machine code instructions of the packet as no-operations (NOPs) and transmit the machine code instructions of the packet to a coprocessor. The coprocessor may then decode and execute the machine code instructions. The method may further include the processor core keeping responsibility for load and store operations and, in the case of coprocessor operations, using registers of the coprocessor as source and destination for load and store operations.

### CROSS-REFERENCE TO RELATED APPLICATIONS

This application claims priority to Indian Patent Application 202441052912, filed July 10, 2024, the disclosure of which is hereby incorporated by reference in its entirety.

### TECHNICAL FIELD

The present disclosure is related generally to computing systems and methods that use coprocessors and, more specifically, to computing systems and methods for providing instructions to coprocessors.

### BACKGROUND

Computer processor cores are designed to have hardware logic to support an instruction set. In short, an instruction set is a collection of machine code instructions that a given processor core can execute to perform various operations. It is generally expected that a larger instruction set may allow for more efficient or robust coding.

Furthermore, some computer systems use coprocessors to offload some processing responsibilities from a main processor core. Such computer systems may reserve a subset of the instruction set for use by the coprocessors. However, because the size of the subset may be fixed long before the coprocessors are added, the reserved subset may be appropriate for some applications, but the size of the subset may be considered smaller than desirable for other applications.

### SUMMARY

In an arrangement, a method includes: fetching, by a processor core, an instruction packet having a plurality of machine code instructions; determining whether a first machine code instruction of the plurality of machine code instructions corresponds to a coprocessor operation; and in response to determining that the first machine code instruction corresponds to the coprocessor operation, transmitting a second machine code instruction of the plurality of machine code instructions from the processor core to a coprocessor.

In an arrangement, a system includes: a processor core having hardware logic and a decoder; a memory; and a coprocessor; wherein the processor core is configured to: fetch a plurality of machine code instructions from the memory; decode a first machine code instruction of the plurality of machine code instructions, using the decoder; determine by the hardware logic that a second machine code instruction of the plurality of machine code instructions corresponds to a no-operation based on output from the decoder; and transmit the second machine code instruction to the coprocessor based on the output from the decoder.

In another arrangement, a non-transitory computer readable medium storing computer executable code, which when executed by one or more processors causes the one or more processors to perform actions, wherein the computer executable code includes: a plurality of machine code instructions including: a first machine code instruction having a first opcode that is configured to indicate that the plurality of machine code instructions corresponds to a coprocessor; and a second machine code instruction having a second opcode, wherein the second opcode is configured to correspond to a first operation when executed by the one or more processors and to correspond to a second operation when executed by the coprocessor.

### BRIEF DESCRIPTION OF THE DRAWINGS

Having thus described the invention in general terms, reference will now be made to the accompanying drawings, wherein:

FIG. 1 is an illustration of an example computing system, according to some embodiments.

FIG. 2 is an illustration of an example instruction, according to some embodiments.

FIG. 3 is an illustration of example assembly code of an example packet, according to some embodiments.

FIG. 4 is an illustration of an example method for executing code, according to some embodiments.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Various embodiments provide techniques to reuse an opcode space of a processor core for a coprocessor. As noted above, some instruction sets include a reserved subset of instructions (each of the instructions having a corresponding opcode) for use by a coprocessor. Examples include the Arm instruction set used by processors that use cores designed and licensed by Arm Limited and the RISC-V instruction set used by processors that include RISC-V processor cores. Such instruction sets include instruction set extensions, where the extensions refer to a reserved subset of opcodes that can be used for coprocessors. However, some engineers may find that the quantity of reserved opcodes in the extensions to be smaller than is desirable.

By contrast, various embodiments may allow the main processor core and the various processor cores to share all or almost all of the instruction set space (i.e., the possible combinations of opcode values). In one example, a given opcode value may be decoded and executed as a first instruction (e.g., an add operation) by the main processor core and that same opcode value, if designated for a coprocessor, may be decoded and executed as a second and different instruction (e.g., a shift or rotate operation) by the coprocessor. Such performance may depend on how the different hardware logic of the processor core and the coprocessor are designed.

In one example, a processor core fetches instructions as a group of instructions, sometimes referred to as a packet. Such example processor core may use multiple functional units with the ability to execute multiple instructions in a single clock cycle by packing multiple instructions in an instruction packet. Each such instruction packet can contain one or more instructions and, in some examples, all the instructions in a given instruction packet will be executed in parallel.

Therefore, the packet may include multiple (e.g., up to eight or more) instructions. In an example, the processor core allocates the instructions of a first packet among various functional units of the processor core for execution. The processor core may then decode a first instruction of a second packet. The first instruction may be designated as corresponding to a coprocessor operation. In response, the processor core may then treat the first instruction of the second packet as a no-operation (e.g., NOP) and then transmit the other instructions of the second packet to the coprocessor instead of allocating to the functional units of the processor core. The coprocessor may then decode and execute the provided instructions from the second packet using its pipeline. In one example, the processor core may transmit the other instructions to the coprocessor using hardware signaling or other appropriate technique.

Continuing with the example, the pipeline of the coprocessor may decode and execute the other instructions according to the hardware logic of the coprocessor. Further, the other instructions may include opcodes that may be used by the processor core for the same or different instructions. Therefore, while the opcodes of the instructions may be decoded and executed in a particular way by the coprocessor, the processor core may include hardware logic to decode and execute the same opcode values, either in the same way or a different way as the coprocessor may decode and execute those opcodes values.

An advantage of such embodiments is that the coprocessor may have a larger instruction set than it would otherwise have if it was limited to a subset of the possible opcode values set aside for instruction set extensions. As a result, a programmer may have more ability to write robust code to be executed on the coprocessor. Such additional instructions available to the coprocessor may further allow for faster and more efficient operation of the coprocessor.

Furthermore, some embodiments may retain the addressing modes and load store capability of the processor core. In one example, a packet includes a first instruction that specifies the packet includes coprocessor instruction, a set of load and store instructions, and a set of other instructions. The other instructions in the packet are treated as corresponding to a coprocessor operation, but the processor core may determine to decode and execute load and store instructions on behalf of the coprocessor. For example, the processor core may use registers within the coprocessor as source and destination registers for the load and store instructions. In other words, for load and store instructions, the processor core may issue memory accesses as it would normally do, however the processor core may load and store with respect to registers of the coprocessor.

An advantage of such an embodiment may include a simpler design by avoiding multiple instantiations of addressing hardware logic and load store hardware logic. For instance, a processor core may include a rich set of addressing modes and load store functionality. Embodiments that may use the processor core (rather than the coprocessor) to perform load and store operations may leverage that functionality by omitting to include load and store hardware specifically for and in the coprocessor. Another advantage may include that the compiler may be allowed to see the coprocessor registers as a direct extension of the processor core, thereby causing no additional complexity for the compiler.

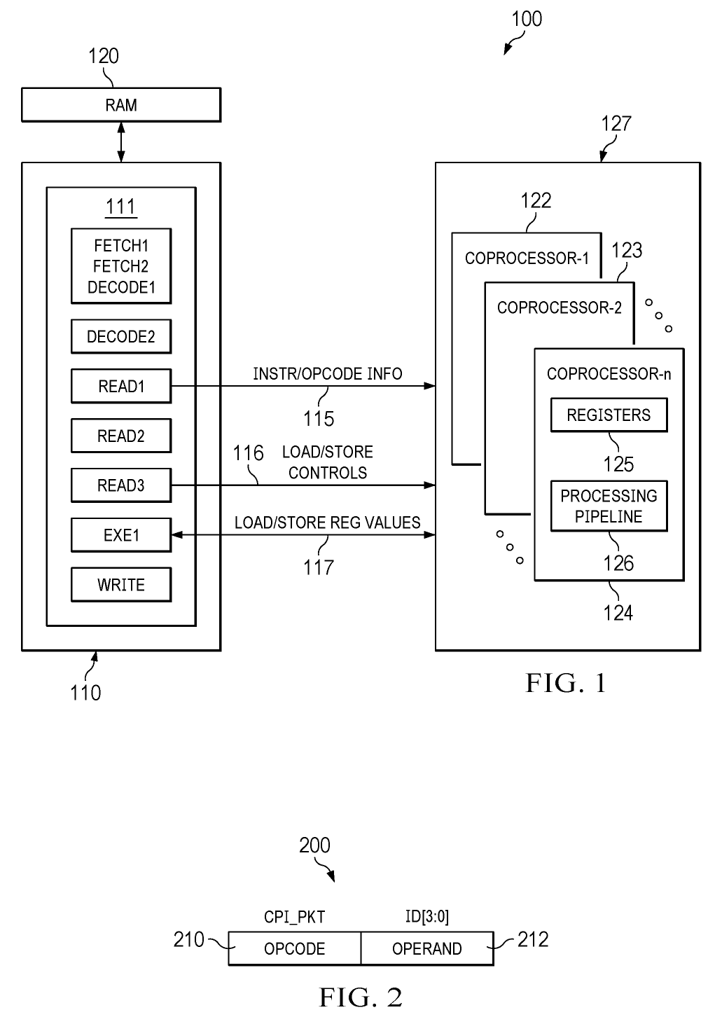

FIG. 1 is an illustration of an example computing system 100, according to some embodiments. System 100 includes processor core 110, and processor core 110 includes a processing pipeline 111. Processing pipeline 111 is implemented using hardware logic, and it includes a plurality of stages. In this example, processing pipeline 111 includes multiple Fetch stages, multiple Decode stages, multiple Read stages, one or more Execute stages(EXE1), and a Write stage. The processor core 110 may use processing pipeline 111 to fetch, decode, and execute computer instructions.

In one example, the Fetch stages of processing pipeline 111 may fetch a packet of machine code instructions from RAM 120. In this example, RAM 120 may include any appropriate type of random-access memory and may be utilized as main memory for system 100. However, various embodiments may use any appropriate volatile or non-volatile memory structure. The processing pipeline 111 may then begin decoding the machine code instructions using the Decode stages. Assuming the packet of machine code instructions is intended for processor core 110, the processing pipeline 111 may continue to process the decoded instructions from the Read stages through the Execute stage(s) and the Write stage.

Processor core 110 may be implemented in any appropriate manner. For instance, processor core 110 may be implemented as a general-purpose processor core, a graphics processing unit (GPU), a reduced instruction set computer (RISC), and/or the like. In one particular example, processor core 110 may be implemented as a RISC-V processor or an Arm Cortex processor, such as may be available from Arm Limited. Nevertheless, the scope of implementations is not limited to any processor core architecture.

Additionally, though system 100 is illustrated as including only a single processor core 110, it is understood that various embodiments may include multiple processor cores, some of which may communicate with the coprocessors 122-124, and some of which may be unable to communicate directly with coprocessors 122-124.

As noted above, system 100 includes multiple coprocessors 122-124 in coprocessor system 127. In this example, the system 100 includes processor cores 1-n, where n may be any appropriate integer greater than zero. Each of the coprocessors is implemented with registers, such as are illustrated as registers 125 of coprocessor 124. Furthermore, each of the coprocessors is implemented with a processing pipeline, as is illustrated by processing pipeline 126. Processor pipeline 126 may be the same as or similar to processing pipeline 111.

In one example use case, the processor core 110 may fetch a packet of machine code instructions from RAM 120, using its Fetch stages of processing pipeline 111. The processor core 110 may then begin to decode the machine code instructions of the packet, including the first machine code instruction of the packet. The first machine code instruction may be similar to machine code instruction 200 of FIG. 2, and the hardware logic of the processing pipeline 111 is configured so that the Decode stages determine that the first machine code instruction corresponds to a coprocessor operation. The processing pipeline 111 then treats the opcode of the first machine code instruction as a NOP and further transmits opcodes and operands corresponding to the other machine code instructions of the packet using the hardware signals 115.

Continuing with the example, the first machine code instruction of the packet may include an operand identifying one of the coprocessors 122-124. For ease of illustration, this example will refer to coprocessor 124 being the identified coprocessor. Coprocessor 124 receives the opcodes and operands of the other machine code instructions of the packet and uses its processing pipeline 126 to decode the machine code instructions and execute the decoded machine code instructions.

The hardware logic of processing pipeline 126 is configured to use a same (or at least mostly the same) instruction set space (range possible of opcode values) as the processor core 110. However, the hardware logic of the processing pipeline 126 may be different from the hardware logic of the processing pipeline 111, thereby allowing processing pipeline 126 and processing pipeline 111 to decode a same opcode value differently and to perform different resultant actions based on a same opcode.

Example system 100 may include further functionality to handle load and store operations. As noted above, some implementations may include the processor core 110 treating all instructions within a packet of instructions as coprocessor instructions based upon decoding a first one of the instructions having an opcode corresponding to a coprocessor operation. However, some embodiments may use the addressing mode functionality and load store functionality of the processor core 110. In other words, in some embodiments, the processor core 110 may perform the load and store operations using coprocessor registers (registers 125) as the destination registers for load operations and the source registers for store operations in response to the opcode corresponding to the coprocessor operation. Furthermore, in such example, other instructions that are not load store operations may be transmitted to the coprocessor 124 and treated as a NOP by the processing pipeline 111.

In an embodiment that uses the processing pipeline 111 for load and store operations, the processing pipeline 111 may use hardware signals 116 to perform load and store controls on the registers 125 and may then use hardware signals 117 to read and write values to and from the registers 125.

In one example, the processor 110 may fetch a packet of machine code instructions from RAM 120, decode and execute those machine code instructions, fetch a subsequent packet of machine code instructions, and on and on. Some of the packets may be designated for coprocessor operations, whereas others of those packets may be designated for execution by processing pipeline 111. A program application may include compiled machine code instructions in RAM 120, and the processing pipeline 111 may fetch packets from the RAM 120 according to a program counter (not shown). The program application may be written so that some of the processing burden may be offloaded to the coprocessors 122-124. Specifically, the program application may have some packets that are designated for coprocessor operations and other packets that are not designated for coprocessor operations, and the processing pipeline 111 may be configured to recognize those packets that are designated for coprocessor operations and transmit opcodes and perform load and store operations accordingly.

System 100 may be implemented on a same semiconductor die (e.g., as a system on-chip) or on multiple semiconductor dies. Furthermore, the one or multiple semiconductor dies may be packaged into a semiconductor package.

FIG. 2 is an illustration of example instruction 200, according to some embodiments. Instruction 200 is an example of a machine code instruction, which may be fetched from RAM 120 and may be fetched as part of a packet of machine code instructions.

Instruction 200 includes an opcode 210 and an operand 212. Generally, an opcode, such as opcode 210, is the part of a machine code instruction that specifies an operation to be performed. It is associated with a unique value (e.g., in binary digits) that may be decoded to a command that the processor understands. For instance, an instruction set may include 16-bit instructions, where each instruction may include an opcode that may be less than the full 16 bits. An opcode may include binary digits, and a decode stage of a processing pipeline may receive the binary digits of the opcode and decode those binary digits to perform a specific function. Examples of functions may include add, subtract, load, store, shift, and the like.

In the present example, the opcode 210 is represented by the mnemonic term CPI_PKT, and it designates the packet as being associated with a coprocessor operation. The mnemonic term is understandable by humans, and the actual contents of the opcode 210 in an example use case would be expected to be a binary value.

Instruction 200 further includes operand 212, which is a value on which the operation of the opcode is performed. In this example, the operand 212 may include any one of sixteen different values 0-15 and, thus, may be implemented as four binary digits. In the example of FIG. 2, the operand 212 may include data that designates one of the coprocessors 122-124. The quantity of bits of the operand 212 may be scaled as appropriate to be addressable to any number of coprocessors in a given system. The scope of implementations is not limited to any size of operand or opcode, as any appropriate size may be used.

The processing pipeline 111 of FIG. 1 is configured so that when it decodes the binary numeric value of opcode 210, it recognizes that the packet in which the instruction 200 was fetched is associated with a coprocessor operation. The processing pipeline 111 is also configured to decode the value of the operand 212, which designates which particular coprocessor is intended to decode and execute the other machine code instructions of the packet.

In this particular example, the processing pipeline 111 is configured so that when it decodes the value of CPI_PKT in the opcode 210, it treats the entire packet as a coprocessor operation. Furthermore, some embodiments may prohibit mixing coprocessor operations and processor core operations within a single packet, thereby simplifying coding and compiling.

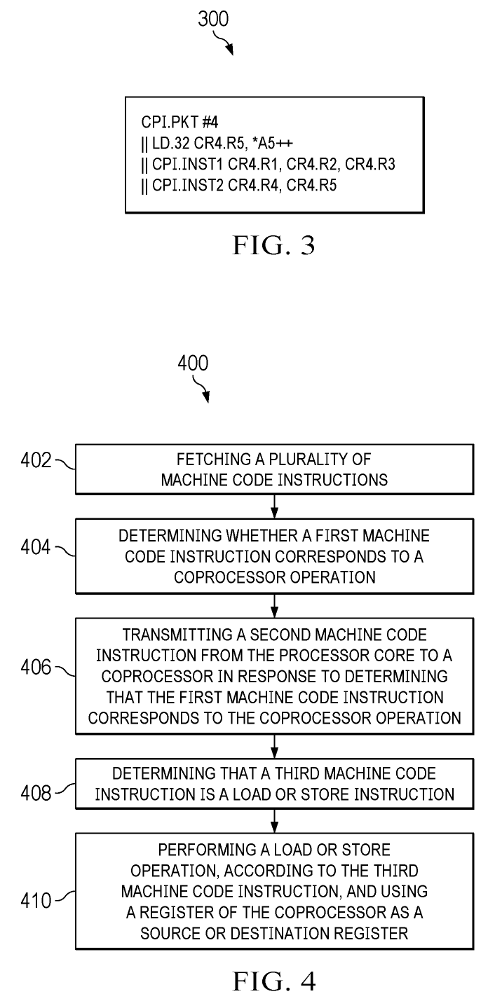

FIG. 3 is an illustration of example assembly code 300 of an example packet, according to some embodiments. For instance, the machine code instruction 200 may be fetched as part of a packet, such as may be represented by the assembly code 300. In this example, the assembly code 300 includes mnemonic representations of instructions, and it is understood that the instructions as they are fetched from RAM 120 would be implemented as values in binary form. Assembly code 300 is used for ease of illustration.

The first line of the assembly code 300 includes CPI.PKT #4. This represents the opcode 210 of FIG. 2 (CPI_PKT) and an identifier of a coprocessor #4. For instance, the #4 coprocessor may refer to anyone of coprocessors 122-124, though for ease of illustration this example will refer to coprocessor 124. The processing pipeline 111 is configured to treat the other instructions of the packet as being associated with a coprocessor operation upon decoding the first instruction of the packet – CPI.PKT #4.

The second line of assembly code 300 includes “LD.32 CR4.R5, *A5++”. This is a mnemonic that represents a load operation. The processing pipeline 111 is configured to interpret this load instruction as a load instruction that it performs but using the CR4.R5 register addresses of coprocessor 124 as destination register addresses. Looking at FIG. 1, the processing pipeline 111 may use the signals 116 and 117 for the load operation to the register addresses in the coprocessor 124. The value *A5++ indicates a particular addressing mode for the processing pipeline 111.

The third line in the assembly code 300 includes “CPI.INST1 CR4.R1, CR4.R2, CR4.R3”. The mnemonic term CPI.INST1 represents a first opcode from the instruction set. The processing pipeline 126 is configured to decode this opcode and to perform a particular operation with respect to the register addresses CR4.R1, CR4.R2, and CR4.R3 of the operand. The register addresses in this example are within the registers 125 of the coprocessor 124. The particular operation associated with the opcode may be any appropriate operation, and it may be a same operation or a different operation that would be associated with the same opcode if the same opcode was decoded and executed by processing pipeline 111.

The fourth line in the assembly code 300 includes, “CPI.INST2 CR4.R4, CR4.R5.” Similar to the third line in the assembly code, the fourth line includes an opcode represented by the mnemonic CPI.INST2. The opcode represents an operation that may be performed with respect to the register addresses CR4.R4 and CR4.R5 of the operand.

In one example use case, the processing pipeline 111 may fetch the packet represented by the assembly code 300 and begin decoding the instructions therein. Upon decoding the instruction of the first line (e.g., such as may be represented by instruction 200 of FIG. 2) the processing pipeline 111 determines that the entire packet is associated with a coprocessor operation. The processor core 110 then uses hardware signals 115 to transmit at least some of the contents of the packet to the designated coprocessor, which in this case is coprocessor 124.

The hardware signals may include, e.g., opcodes and operands of the load operation and the two CPI.INST operations. However, in some examples the processor core 110 may decode and execute the load operation and may, therefore, mark the load operation as invalid in hardware signal 115 and may mark the CPI.INST operations as valid in the hardware signal 115. The coprocessor 124, receiving the hardware signal 115 may then begin to decode and execute the instructions marked as valid. Furthermore, upon decoding the CPI.PKT operand in the first line of assembly code 300, the processing pipeline 111 may treat the CPI.INST operations as NOPs in response.

While FIG. 3 illustrates a packet having four total instructions, the scope of embodiments may include any appropriately sized packet having an appropriate quantity of instructions therein. The quantity of instructions within a given packet may be determined according to the hardware capability of the processing pipeline 111.

Instruction 200 of FIG. 2 and the instructions of assembly code 300 of FIG. 3 may be stored as computer executable code on a non-transitory computer readable medium. An example of computer readable media may include RAM 120 of FIG. 1 or any other appropriate non-transitory computer readable media.

FIG. 4 is an illustration of example method 400, for executing code, according to some embodiments. FIG. 4 includes actions 402-410, which may be performed by a processing pipeline of a processor core, such as processing pipeline 111 of processor core 110.

Action 402, the processing pipeline fetches a plurality of machine code instructions. For instance, the processing pipeline may have hardware logic that is configured to fetch a group of machine code instructions as a packet. Put another way, a single fetch operation or a group of related fetch operations may move multiple machine code instructions from memory to the processing pipeline. Furthermore, in this example, the processing pipeline may treat each of the machine code instructions of the packet as either being associated with a coprocessor operation or not.

At action 404, the processing pipeline determines whether a first machine code instruction of the packet corresponds to a coprocessor operation. In the examples above of FIGS. 2 and 3, a particular opcode (e.g., CPI_PKT) may be used to designate that the machine code instructions of a packet are associated with a coprocessor operation. In one example of action 404, the processing pipeline decodes or at least partially decodes the first machine code instruction, including decoding the opcode. Decoding the opcode then causes the hardware logic of the processing pipeline to determine that the entire packet is associated with the coprocessor operation. Furthermore, an operand of the machine code instruction may designate a particular coprocessor, among a group of coprocessors, for the coprocessor operation.

At action 406, the processing pipeline transmits a second machine code instruction from the processor core to a coprocessor. This is performed in response to determining that the packet is associated with the coprocessor operation at action 404. For instance, the processing pipeline may use hardware signals, such as hardware signals 115, to transmit the other instructions in the packet to the coprocessor. The hardware signals 115 may include any appropriate information to facilitate decoding and executing by the coprocessor. For instance, the hardware signals 115 may include markers to indicate which ones of the instructions of the packet for the coprocessor to decode and execute. In one example, the processor core may retain addressing and load store functionality, so that the hardware signals 115 may mark the load store operations as invalid. On the other hand, the hardware signals 115 may mark other instructions, such as the second machine code instruction, as valid to cause the processing pipeline of the coprocessor to decode and execute those other instructions.

Further in this example, the processing pipeline of the processor core may treat the instructions in the packet, other than load store instructions, as NOPs. The processing pipeline of the coprocessor may treat instructions marked as invalid as NOPs.

At action 408, the processing pipeline determines that a third machine code instruction is a load or store instruction. For instance, the processing pipeline may be configured to decode or partially decode opcodes of the instructions in the packet and determine to decode and execute to completion the load and store instructions of the packet. In the example of FIG. 3, the instruction using the mnemonic LD.32 may be recognized by the processing pipeline as a load instruction and in response, the processing pipeline of the processor core may decode and execute that instruction. However, the processing pipeline of the processor core may treat the other instructions CPI.INST as NOPs.

At action 410, the processing pipeline performs a load or store operation according to the third machine code instruction and based on the determination at action 408. Specifically, the processing pipeline of the processor core may perform a load or store operation according to the third machine code instruction and in response to the first machine code instruction of action 404. However, the processing pipeline of the processor core may use a register (or registers) of the coprocessor as a source or destination.

The scope of implementations is not limited to the series of actions 402-410. Rather, other implementations may add, omit, rearrange, or modify ones of the actions. For instance, some implementations may include the processing pipeline of the processor core continuing to fetch packets of machine code instructions. Some of those packets may include an operand to indicate that the entire packet is associated with a coprocessor operation, and other packets may not include such operand and may be treated as a default as corresponding to an operation of the processor core itself. In fact, a further instruction packet that is not associated with a coprocessor operation may include a same opcode as in the second machine code instruction of action 406, though that opcode may correspond to a different operation of the processor core then what was performed by the coprocessor in response to action 406. In other words, the set of machine code instructions may have some instructions that are decoded the same by the processor core and by a coprocessor and other machine code instructions that are decoded differently by the processor core and by the coprocessor. In fact, it is possible for an engineer to re-use the entirety or nearly the entirety of the instruction set of the processor core for coprocessor operations.

Corresponding numerals and symbols in the different figures generally refer to corresponding parts, unless otherwise indicated. The figures are not necessarily drawn to scale. In the drawings, like reference numerals refer to like elements throughout, and the various features are not necessarily drawn to scale.

The term “semiconductor die” is used herein. A semiconductor device can be a discrete semiconductor device such as a bipolar transistor, a few discrete devices such as a pair of power FET switches fabricated together on a single semiconductor die, or a semiconductor die can be an integrated circuit with multiple semiconductor devices such as the multiple capacitors in an A/D converter. The semiconductor device can include passive devices such as resistors, inductors, filters, sensors, or active devices such as transistors. The semiconductor device can be an integrated circuit with hundreds or thousands of transistors coupled to form a functional circuit, for example a microprocessor or memory device. The semiconductor device may also be referred to herein as a semiconductor device or an integrated circuit (IC) die.

The term “semiconductor package” is used herein. A semiconductor package has at least one semiconductor die electrically coupled to terminals and has a package body that protects and covers the semiconductor die. In some arrangements, multiple semiconductor dies can be packaged together. For example, a power metal oxide semiconductor (MOS) field effect transistor (FET) semiconductor device and a second semiconductor device (such as a gate driver die, or a controller die) can be packaged together to from a single packaged electronic device. Additional components such as passive components, such as capacitors, resistors, and inductors or coils, can be included in the packaged electronic device. The semiconductor die is mounted with a package substrate that provides conductive leads. A portion of the conductive leads form the terminals for the packaged device. In wire bonded integrated circuit packages, bond wires couple conductive leads of a package substrate to bond pads on the semiconductor die. The semiconductor die can be mounted to the package substrate with a device side surface facing away from the substrate and a backside surface facing and mounted to a die pad of the package substrate. The semiconductor package can have a package body formed by a thermoset epoxy resin mold compound in a molding process, or by the use of epoxy, plastics, or resins that are liquid at room temperature and are subsequently cured. The package body may provide a hermetic package for the packaged device. The package body may be formed in a mold using an encapsulation process, however, a portion of the leads of the package substrate are not covered during encapsulation, these exposed lead portions form the terminals for the semiconductor package. The semiconductor package may also be referred to as a “integrated circuit package,” a “microelectronic device package,” or a “semiconductor device package.”

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. A method comprising:
fetching, by a processor core, an instruction packet having a plurality of machine code instructions
determining whether a first machine code instruction of the plurality of machine code instructions corresponds to a coprocessor operation; and
in response to determining that the first machine code instruction corresponds to the coprocessor operation, transmitting a second machine code instruction of the plurality of machine code instructions from the processor core to a coprocessor.

2. The method of claim 1, further comprising:
in response to determining that the first machine code instruction corresponds to the coprocessor operation, treating the second machine code instruction as a no-operation for the processor core.

3. The method of claim 1, wherein transmitting the second machine code instruction to the coprocessor comprises:
signaling, using hardware signals, an opcode of the second machine code instruction to the coprocessor.

4. The method of claim 1, wherein determining whether the first machine code instruction corresponds to the coprocessor operation comprises:
decoding the first machine code instruction, wherein the first machine code instruction includes an opcode and an operand, wherein the opcode corresponds to the coprocessor operation, and wherein the operand identifies the coprocessor among a plurality of coprocessors.

5. The method of claim 4, further comprising:
determining whether to transmit the second machine code instruction to the coprocessor or another coprocessor of the plurality of coprocessors based on the operand.

6. The method of claim 1, further comprising:
in response to determining that the first machine code instruction corresponds to the coprocessor operation, determining that a third machine code instruction of the plurality of machine code instructions is a load instruction; and
performing a load operation, according to the load instruction, by the processor core and using a register of the coprocessor as a destination register.

7. The method of claim 1, further comprising:
in response to determining that the first machine code instruction corresponds to the coprocessor operation, determining that a third machine code instruction of the plurality of machine code instructions is a store instruction; and
performing a store operation, according to the store instruction, by the processor core and using a register of the coprocessor as a source register.

8. The method of claim 1, further comprising:
receiving the second machine code instruction at the coprocessor;
decoding the second machine code instruction by the coprocessor to generate a decoded instruction; and
executing the decoded instruction by the coprocessor.

9. The method of claim 8, further comprising:
fetching a subsequent instruction packet having a subsequent plurality of machine code instructions by the processor core, wherein a third machine code instruction of the subsequent plurality of machine code instructions has a same opcode as the second machine code instruction; and
decoding the third machine code instruction of the plurality of machine code instructions by the processor core to generate a subsequent decoded instruction, wherein the subsequent decoded instruction is different from the decoded instruction.

10. The method of claim 1, wherein the instruction packet includes the plurality of machine code instructions configured for processing in a same clock cycle.

11. A system comprising:
a processor core having hardware logic and a decoder;
a memory; and
a coprocessor;
wherein the processor core is configured to:
fetch a plurality of machine code instructions from the memory;
decode a first machine code instruction of the plurality of machine code instructions, using the decoder;
determine by the hardware logic that a second machine code instruction of the plurality of machine code instructions corresponds to a no-operation for the processor core based on output from the decoder; and
transmit the second machine code instruction to the coprocessor based on the output from the decoder.

12. The system of claim 11, wherein the processor core is further configured to:
determine that all machine code instructions of the plurality of machine code instructions, except for any load or store instructions, correspond to no-operations based on the output from the decoder.

13. The system of claim 11, wherein the processor core is further configured to:
decode a third machine code instruction of the plurality of machine code instructions to generate a decoded instruction; and
perform a load operation according to the decoded instruction by the processor core, including using a register within the coprocessor as a destination register.

14. The system of claim 13, wherein the processor core is further configured to:
decode a fourth machine code instruction of the plurality of machine code instructions to generate a further decoded instruction; and
perform a store operation according to the further decoded instruction by the processor core, including using another register within the coprocessor as a source register.

15. The system of claim 11, wherein the processor core is configured to transmit the second machine code instruction using a plurality of hardware signals, wherein the plurality of hardware signals are configured to carry data indicating an opcode of the second machine code instruction.

16. The system of claim 11, wherein the processor core is configured to determine that an opcode of the first machine code instruction is associated with a coprocessor operation.

17. The system of claim 16, wherein the processor core is further configured to transmit the second machine code instruction to the coprocessor based on an operand of the first machine code instruction, where the operand is configured to identify the coprocessor.

18. A non-transitory computer readable medium storing computer executable code, which when executed by one or more processors causes the one or more processors to perform actions, wherein the computer executable code comprises:
a plurality of machine code instructions including:
a first machine code instruction having a first opcode that is configured to indicate that the plurality of machine code instructions corresponds to a coprocessor; and
a second machine code instruction having a second opcode, wherein the second opcode is configured to correspond to a first operation when executed by the one or more processors and to correspond to a second operation when executed by the coprocessor.

19. The non-transitory computer readable medium of claim 18, wherein the first machine code instruction further has an operand identifying the coprocessor among a plurality of coprocessors.

20. The non-transitory computer readable medium of claim 18, wherein the plurality of machine code instructions further includes a third machine code instruction, wherein the third machine code instruction is a load or store instruction having an operand that identifies a register in the coprocessor as a source or destination register.
